(19) United States
(12) Patent Application Publication
(10) Pub. No.: US 2024/0155558 A1
(43) Pub. Date: May 9, 2024

(54) PAGING CONTROL INFORMATION MONITORING METHOD AND APPARATUS, AND PAGING CONTROL INFORMATION INDICATING METHOD AND APPARATUS

(71) Applicant: BEIJING XIAOMI MOBILE SOFTWARE CO., LTD., Beijing (CN)

(72) Inventors: Rao SHI, Beijing (CN); Ting FU, Beijing (CN)

(73) Assignee: BEIJING XIAOMI MOBILE SOFTWARE CO., LTD., Beijing (CN)

(21) Appl. No.: 18/280,936

(22) PCT Filed: Mar. 8, 2021
(86) PCT No.: PCT/CN2021/079574

§ 371 Date: Sep. 7, 2023

(51) Int. Cl. H04W 68/02

(52) U.S. Cl. CPC H04W 68/02

(57) ABSTRACT

The present disclosure relates to the technical field of wireless communications and provides a method and apparatus for monitoring paging control information, and a method and apparatus for indicating paging control information. In one method, a user equipment detects a PEI on a paging early indication (PEI) monitoring occasion to obtain a detection result; and determines, according to the detection result, whether to monitor paging control information on a target paging occasion.

### CROSS-REFERENCE TO RELATED APPLICATION

The present application is the U.S. National phase application of International Application No. PCT/CN2021/079574, filed on Mar. 8, 2021, the entire content of which is incorporated herein by reference for all purposes.

### TECHNICAL FIELD

The present disclosure relates to the field of mobile communications, and in particular, to a method for monitoring paging control information, a method for indicating paging control information, communication devices, and a computer storage medium.

### BACKGROUND

In New Radio (NR) technology, paging messages are broadcasted over the network. The functions of the paging message includes, but is not limited to:
1) The network sends a paging request to the User Equipment (UE) in the Radio Resource Control Idle (RRC IDLE) state.
2) The network notifies UEs in the RRC IDLE state, the RRC INACTIVE state and the RRC_CONNECTED state of a change in system information.
3) The network notifies the UEs to start receiving Earthquake and Tsunami Warning System (ETWS) Primary notification instruction(s) and/or ETWS Secondary notification instruction(s).
4) The network notifies the UEs to start receiving Commercial Mobile Alert Service (CMAS) notification instruction(s).

### SUMMARY

According to a first aspect of the present disclosure, a method for monitoring paging control information is provided, which is performed by a UE. The method includes: detecting a Paging Early Indication (PEI) on a PEI monitoring occasion to obtain a detection result, where the PEI is configured to indicate whether paging control information exists on a plurality of paging occasions; and determine, based on the detection result, whether to monitor the paging control information on a target paging occasion, where the target paging occasion is one of the plurality of paging occasions.

According to a second aspect of the present disclosure, a method for indicating paging control information is provided, which is performed by a network side device. The method includes: sending a Paging Early Indication (PEI) on a PEI sending occasion, wherein the PEI is configured to indicate whether paging control information exists on a plurality of paging occasions.

According to a third aspect of the present disclosure, a communication device is provided, including at least one processor; and a memory connected in communication with the at least one processor; wherein the memory stores instructions that can be executed by the at least one processor to enable the at least one processor to execute the method for monitoring the paging control information as described in the first aspect of the present disclosure, or the method for indicating the paging control information as described in the second aspect of the present disclosure.

According to a fourth aspect of the present disclosure, a non-transitory computer storage medium is provided, the computer storage medium storing computer-executable instructions which, when executed by a processor, cause the processor to implement the method for monitoring the paging control information as described in the first aspect of the present disclosure, or the method for indicating the paging control information as described in the second aspect of the present disclosure.

Additional aspects and advantages of the present disclosure will be described in part in the following description, some of which will become apparent from the following description, or will be learned through the practice of the present disclosure.

### BRIEF DESCRIPTION OF THE DRAWINGS

The foregoing and/or additional aspects and advantages of the present disclosure will become apparent and easily understood from the following description of embodiments in conjunction with the accompanying drawings.

FIG. 1 is a schematic diagram of a method for monitoring paging control information provided by embodiments of the present disclosure.

FIG. 2 is a schematic diagram of another method for monitoring paging control information provided by embodiments of the present disclosure.

FIG. 3 is a schematic diagram of yet another method for monitoring paging control information provided by embodiments of the present disclosure.

FIG. 4 is a schematic diagram of yet another method for monitoring paging control information provided by embodiments of the present disclosure.

FIG. 5 is a schematic diagram of yet another method for monitoring paging control information provided by embodiments of the present disclosure.

FIG. 6 is a schematic diagram of yet another method for monitoring paging control information provided by embodiments of the present disclosure.

FIG. 7 is a schematic diagram of a relationship between a PEI and a PO provided by embodiments of the present disclosure.

FIG. 8 is a schematic diagram of a method for indicating paging control information provided by embodiments of the present disclosure.

FIG. 9 is a schematic diagram of a method for indicating paging control information provided by embodiments of the present disclosure.

FIG. 10 is a schematic diagram of a structure of an apparatus for monitoring paging control information provided by the present disclosure.

FIG. 11 is a schematic diagram of a structure of an apparatus for indicating paging control information provided by the present disclosure.

FIG. 12 is a schematic diagram of a communication device provided by embodiments of the present disclosure.

### DETAILED DESCRIPTION

Exemplary embodiments will be described herein in detail, examples of which are illustrated in the accompanying drawings. When the following description relates to the accompanying drawings, the same numerals in different accompanying drawings indicate the same or similar elements unless otherwise indicated. The implementations described in the following exemplary embodiments do not represent all the embodiments that are consistent with the present disclosure. Rather, they are only examples of devices and methods that are consistent with some aspects of the present disclosure, as detailed in the appended claims.

The terms used in embodiments of the present disclosure are intended to describe particular embodiments only, and are not intended to limit embodiments of the present disclosure. The singular forms of “a/an” and “this” as used in the embodiments of the present disclosure and the appended claims are also intended to include plural forms unless the context clearly indicates otherwise. It should also be understood that the term “and/or” as used herein refers to and encompasses any or all possible combinations of one or more of the associated listed items.

It should be understood that although the terms “first”, “second”, and “third”, etc. may be used in the embodiments of the present disclosure to describe various kinds of information, the information should not be limited by these terms. These terms are used only to distinguish the same type of information from one another. For example, without departing from the scope of embodiments of the present disclosure, first information may also be referred to as second information, and similarly, second information may also be referred to as first information, depending on the context. For example, the word “if” or “in case of” as used herein may be interpreted as “at the time of . . . ,” or “when . . . ,” or “in response to determining . . . .”

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

Embodiments of the present disclosure are described in detail below, and examples of the embodiments are illustrated in the accompanying drawings, in which the same or similar signs throughout indicate the same or similar elements. The embodiments described below by reference to the accompanying drawings are exemplary and are intended to be used to explain the present disclosure and are not to be construed as limiting the present disclosure.

In some embodiments, during the paging process of the UE, the UE usually determines the corresponding Paging Occasion (PO) based on the paging configuration message, and monitors the paging message on the PO in each Discontinuous Reception (DRX) cycle. However, the paging message sent by the network may not always be present during each DRX cycle, and continuous monitoring on the POs will result in wasted power consumption.

In view of the above, the method and apparatus for monitoring the paging control information, the method and apparatus for indicating the paging control information, the communication device, and the storage medium provided by the present disclosure are described in detail below with reference to the accompanying drawings.

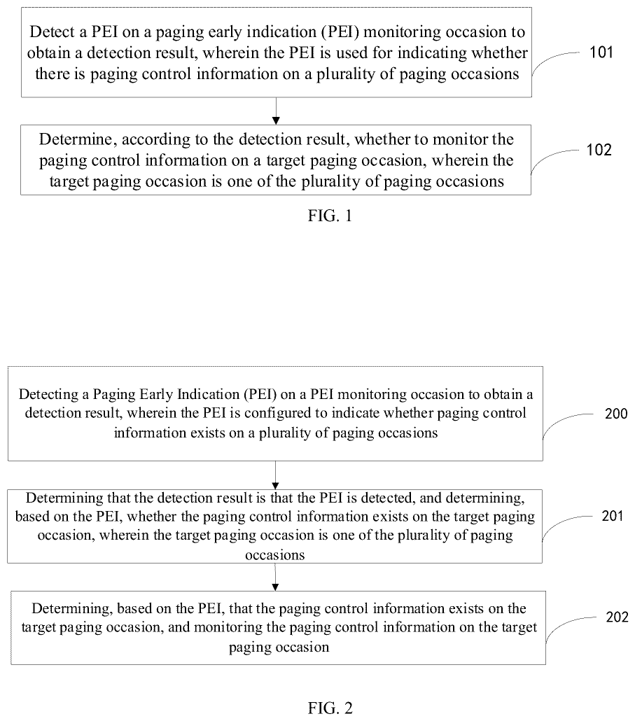

FIG. 1 is a schematic diagram of a method for monitoring the paging control information according to the present disclosure. It should be noted that the method for monitoring the paging control information of the present disclosure can be performed by a User Equipment (UE).

As shown in FIG. 1, the method for monitoring the paging control information provided by the present disclosure may include the following steps.

Step 101, detecting a Paging Early Indication (PEI) on a PEI monitoring occasion to obtain a detection result, wherein the PEI is configured to indicate whether paging control information exists on a plurality of paging occasions.

In some embodiments, there may be one or more PEI monitoring occasions.

Step 102, determining, based on the detection result, whether to monitor the paging control information on a target paging occasion, wherein the target paging occasion is one of the plurality of paging occasions.

In this embodiment, the target paging occasion is a paging occasion that the UE needs to monitor. In some embodiments, the target paging occasion may be predetermined by the UE based on the received paging configuration information. For example, the UE may determine the target paging occasion by calculating it with a formula based on the received paging configuration information.

In some embodiments, when it is determined based on the detection result that the paging control information exists on the target paging occasion, the paging control information can be monitored on the target paging occasion.

In other embodiments, when it is determined based on the detection result that no paging control information exists on the target paging occasion, the UE can enter a sleeping state on the target paging occasion.

In the method for monitoring the paging control information according to the embodiments of the present disclosure, the PEI is detected on the PEI monitoring occasion to obtain the detection result, and based on the detection result, it is determined whether or not to monitor the paging control information on the target paging occasion. Thus, the UE can determine whether to monitor the paging control information on the target paging occasion based on the detection result of the PEI, thereby avoiding the UE from continuously monitoring the paging control information on the PO, and reducing the power consumption of the UE.

In one embodiment of the present disclosure, determining whether to monitor the paging control information on the target paging occasion based on the detection result includes: determining that the detection result is that the PEI is not detected, and continuing to detect the PEI on a next PEI monitoring occasion of the PEI monitoring occasion.

In another embodiment of the present disclosure, determining whether to monitor the paging control information on the target paging occasion based on the detection result includes: determining that the detection result is that the PEI is detected, and determining, based on the PEI, whether to monitor the paging control information on the target paging occasion.

In one embodiment of the present disclosure, determining whether to monitor the paging control information on the target paging occasion based on the PEI is shown in FIG. 2. Accordingly, the method for monitoring the paging control information provided by the present disclosure may include the following steps.

Step 200, detecting a Paging Early Indication (PEI) on a PEI monitoring occasion to obtain a detection result, wherein the PEI is configured to indicate whether paging control information exists on a plurality of paging occasions.

Step 201, determining that the detection result is that the PEI is detected, and determining, based on the PEI, whether the paging control information exists on the target paging occasion, wherein the target paging occasion is one of the plurality of paging occasions.

In this embodiment, the target paging occasion is a paging occasion that the UE needs to monitor. In some embodiments, the target paging occasion may be predetermined by the UE based on the received paging configuration information. For example, the UE may determine the target paging occasion by calculating it with a formula based on the received paging configuration information.

In some embodiments, there may be one or more PEI monitoring occasions.

It can be understood that the above step of determining whether the paging control information exists on the target paging occasion based on the PEI can be implemented in a variety of ways, as exemplarily illustrated below.

In one possible implementation, an indication value on an indication field corresponding to the target paging occasion can be determined based on the PEI; wherein the indication value is configured to indicate whether the paging control information exists on the target paging occasion; and based on the indication value, it is determined that whether the paging control information exists on the target paging occasion.

It can be understood that a plurality of indication fields are included in the PEI, and each indication field is used to indicate the presence or absence of the paging control information on the corresponding paging occasion (PO).

In some embodiments, the indication field may be a 1-bit indication field or a multi-bit indication field, which is not specifically limited in the present disclosure.

In some embodiments, in the case where the indication field is a 1-bit indication field, the presence or absence of the paging control information on the corresponding paging occasion can be indicated by an indication value of the 1-bit indication field. For example, in the case where an indication value of a 1-bit indication field corresponding to a paging occasion is 1, it can be indicated that the paging control information exists on the paging occasion corresponding to the indication field; and in the case where an indication value of a 1-bit indication field corresponding to a paging occasion is 0, it can be indicated that no paging control information exists on the paging occasion corresponding to the indication field.

For another example, in the case where an indication value of a 1-bit indication field corresponding to a paging occasion is 0, it can be indicated that the paging control information exists on the paging occasion corresponding to the indication field; and in the case where an indication value of a 1-bit indication field corresponding to a paging occasion is 1, it can be indicated that no paging control information exists on the paging occasion corresponding to the indication field.

In another possible implementation, sequence information corresponding to the PEI can be determined, and based on the sequence information, it is determined that whether the paging control information exists on the target paging occasion.

Specifically, in the case where the PEI is sent in sequence, the UE can analyze the PEI to determine the sequence information corresponding to the PEI.

In some embodiments, in the case where the sequence information of the PEI is represented in the form of a bitmap, it may be determined based on the sequence information whether the paging control information exists on the target paging occasion.

For example, assuming that the number of paging occasions indicated by the PEI is 3, when the received sequence information is “000”, it may be determined, based on a bit mapping approach, that the sequence information “000” indicates that no paging control information exists on any of the three POs. For another example, when the received sequence information is “001”, it may be determined, based on a bit mapping approach, that the sequence information indicates that no paging control information exists on the first PO as well as on the second PO, while the paging control information exists on the third PO.

In other embodiments, in the case where the PEI is represented by means of a code point, after determining the sequence information corresponding to the PEI which may include a sequence format, determining whether the paging control information exists on the target paging occasion based on the sequence information include: when the sequence format indicates that the paging control information exists on at least two paging occasions, determining that the paging control information exists on the target paging occasion; or when the sequence format indicates that the paging control information exists on the target paging occasion, determining that the paging control information exists on the target paging occasion; or when the sequence format indicates that no paging control information exists on the plurality of paging occasions, determining that no paging control information exists on the target paging occasion.

In some embodiments, in the case where the PEI is represented by means of a code point, after the PEI is detected, a code point corresponding to the PEI can be determined, and then based on the code point, a corresponding sequence format can be determined.

In some embodiments, after the code point is determined, the sequence format corresponding to the code point can be determined based on a communication protocol standard of the UE, and then, based on the information indicated by the sequence format, it can be determined whether the paging control information exists on the target paging occasion corresponding to the UE.

In other embodiments, after the code point is determined, the sequence format corresponding to the code point can be determined based on a correspondence between the code point and the sequence format pre-saved in the UE. Here, different sequence formats denote different meanings.

For example, there are four paging occasions (POs), sequence format 0, sequence format 1, sequence format 2, sequence format 3, sequence format 4, and sequence format 5, wherein sequence format i indicates that the paging control information exists on the corresponding i^{th} PO, the value of i being 0, 1, 2, or 3; sequence format 4 indicates that there are at least two POs on which the paging control information exists; and sequence format 5 indicates that there is no paging control information on any of the four paging occasions.

Step 202, determining, based on the PEI, that the paging control information exists on the target paging occasion, and monitoring the paging control information on the target paging occasion.

That is, in the case where the PEI indicates that the paging control information exists on the target paging occasion, the paging control information is monitored on the target paging occasion.

In the method for monitoring the paging control information according to the embodiments of the present disclosure, when the detection result is that the PEI is detected, based on the PEI, the UE determines whether the paging control information exists on the target paging occasion, and monitors the paging control information on the target paging occasion if the paging control information exists on the target paging occasion. Thus, it is convenient for the UE to determine, based on the PEI, whether the paging control information exists on its own target paging occasion, and then monitor the paging control information on the target paging occasion if the paging control information exists, so as to avoid continuously monitoring the paging control information on the PO, and to reduce the power consumption of the UE.

In another embodiment of the present disclosure, the method for monitoring the paging control information may include: detecting a Paging Early Indication (PEI) on a PEI monitoring occasion to obtain a detection result, wherein the PEI is configured to indicate whether paging control information exists on a plurality of paging occasions; determining that the detection result is that the PEI is detected and the PEI indicates that no paging control information exists on a target paging occasion, and entering a sleeping state on the target paging occasion, wherein the target paging occasion is one of the plurality of paging occasions. Thus, in the case where the detection result is that the PEI is detected and the PEI indicates that no paging control information exists on the target paging occasion, the UE enters a sleeping state on the target paging occasion, thereby avoiding continuously monitoring the paging control information on the PO, and reducing the power consumption of the UE.

In an embodiment of the present disclosure, determining by the UE whether to monitor the paging control information on the target paging occasion based on the detection result includes: determining that the detection result is that the PEI is not detected, determining that no paging control information exists on the target paging occasion, and entering a sleeping state on the target paging occasion.

In another embodiment of the present disclosure, determining by the UE whether to monitor the paging control information on the target paging occasion based on the detection result includes: determining that the detection result is that the PEI is detected, determining whether to monitor the paging control information on the target paging occasion based on the PEI.

FIG. 3 is a schematic diagram of another method for monitoring paging control information provided by the present disclosure, which can be performed by a UE. As shown in FIG. 3, the method for monitoring the paging control information may include the following steps.

Step 300, detecting a Paging Early Indication (PEI) on a PEI monitoring occasion to obtain a detection result, wherein the PEI is configured to indicate whether paging control information exists on a plurality of paging occasions.

The PEI monitoring occasion may be determined by the UE based on the received configuration information of the PEI.

The manner in which the UE determines the PEI monitoring occasion can be referred to in the following description of the embodiments.

Step 301, determining that the detection result is that the PEI is detected, and determining, based on the PEI, whether the paging control information exists on the target paging occasion, wherein the target paging occasion is one of the plurality of paging occasions.

In this embodiment, the target paging occasion is a paging occasion that the UE needs to monitor. In some embodiments, the target paging occasion may be predetermined by the UE based on the received paging configuration information. For example, the UE may determine the target paging occasion by calculating it with a formula based on the received paging configuration information.

In some embodiments, there may be one or more PEI monitoring occasions.

It can be understood that the above step of determining whether the paging control information exists on the target paging occasion based on the PEI can be implemented in a variety of ways, as exemplarily illustrated below.

In one possible implementation, an indication value on an indication field corresponding to the target paging occasion can be determined based on the PEI; wherein the indication value is configured to indicate whether the paging control information exists on the target paging occasion; and based on the indication value, it is determined that whether the paging control information exists on the target paging occasion.

It can be understood that a plurality of indication fields are included in the PEI, and each indication field is used to indicate the presence or absence of the paging control information on the corresponding paging occasion (PO).

In some embodiments, the indication field may be a 1-bit indication field or a multi-bit indication field, which is not specifically limited in the present disclosure.

In some embodiments, in the case where the indication field is a 1-bit indication field, the presence or absence of the paging control information on the corresponding paging occasion can be indicated by an indication value of the 1-bit indication field. For example, in the case where an indication value of a 1-bit indication field corresponding to a paging occasion is 1, it can be indicated that the paging control information exists on the paging occasion corresponding to the indication field; and in the case where an indication value of a 1-bit indication field corresponding to a paging occasion is 0, it can be indicated that no paging control information exists on the paging occasion corresponding to the indication field.

For another example, in the case where an indication value of a 1-bit indication field corresponding to a paging occasion is 0, it can be indicated that the paging control information exists on the paging occasion corresponding to the indication field; and in the case where an indication value of a 1-bit indication field corresponding to a paging occasion is 1, it can be indicated that no paging control information exists on the paging occasion corresponding to the indication field.

In another possible implementation, sequence information corresponding to the PEI can be determined, and based on the sequence information, it is determined that whether the paging control information exists on the target paging occasion.

Specifically, in the case where the PEI is sent in sequence, the UE can analyze the PEI to determine the sequence information corresponding to the PEI.

In some embodiments, in the case where the sequence information of the PEI is represented in the form of a bitmap, it may be determined based on the sequence information whether the paging control information exists on the target paging occasion.

For example, assuming that the number of paging occasions indicated by the PEI is 3, when the received sequence information is “000”, it may be determined, based on a bit mapping approach, that the sequence information “000” indicates that no paging control information exists on any of the three POs. For another example, when the received sequence information is “001”, it may be determined, based on a bit mapping approach, that the sequence information indicates that no paging control information exists on the first PO as well as on the second PO, while the paging control information exists on the third PO.

In other embodiments, in the case where the PEI is represented by means of a code point, after determining the sequence information corresponding to the PEI which may include a sequence format, determining whether the paging control information exists on the target paging occasion based on the sequence information include: when the sequence format indicates that the paging control information exists on at least two paging occasions, determining that the paging control information exists on the target paging occasion; or when the sequence format indicates that the paging control information exists on the target paging occasion, determining that the paging control information exists on the target paging occasion; or when the sequence format indicates that no paging control information exists on the plurality of paging occasions, determining that no paging control information exists on the target paging occasion.

In some embodiments, in the case where the PEI is represented by means of a code point, after the PEI is detected, a code point corresponding to the PEI can be determined, and then based on the code point, a corresponding sequence format can be determined.

In some embodiments, the sequence format corresponding to the code point can be determined based on a communication protocol standard of the UE, and then, based on the information indicated by the sequence format, it can be determined whether the paging control information exists on the target paging occasion corresponding to the UE.

In other embodiments, the sequence format corresponding to the code point can be determined based on a correspondence between the code point and the sequence format pre-saved in the UE. Here, different sequence formats denote different meanings.

For example, there are four paging occasions (POs), sequence format 0, sequence format 1, sequence format 2, sequence format 3, and sequence format 4, wherein sequence format i indicates that the paging control information exists on the corresponding i^{th} PO, the value of i being 0, 1, 2, or 3; sequence format 4 indicates that there are at least two POs on which the paging control information exists. If no paging control information exists on any of the four POs, no PEI will be sent.

Step 302, determining that the PEI indicates that the paging control information exists on the target paging occasion, and monitoring the paging control information on the target paging occasion.

Step 303, determining that the detection result is that PEI is not detected, determining that no paging control information exists on the target paging occasion, and entering a sleeping state on the target paging occasion.

In the method for monitoring paging control information according to the embodiments of the present disclosure, when the detection result is that the PEI is detected, based on the PEI, the UE determines whether the paging control information exists on the target paging occasion and monitors the paging control information on the target paging occasion if the paging control information exists on the target paging occasion; and when the detection result is that no PEI is detected, the UE determines that no paging control information exists on the target paging occasion and enters a sleeping state on the target paging occasion. Thus, if a PEI is detected, the UE is controlled based on the PEI to monitor the paging control information or not on the corresponding target paging occasion, and if no PEI is detected, it is directly determined that there is no paging control information on the target paging occasion, so as to realize the accurate control of whether or not to perform monitoring on the target paging occasion, thus avoiding continuously monitoring the paging control information on the PO, reducing the power consumption of the UE, and thus achieving the purpose of saving the power of the UE.

In an embodiment of the present disclosure, the method for monitoring paging control information may include: detecting a Paging Early Indication (PEI) on a PEI monitoring occasion to obtain a detection result, wherein the PEI is configured to indicate whether paging control information exists on a plurality of paging occasions; determining that the detection result is that the PEI is detected, determining, based on the PEI, whether the paging control information exists on the target paging occasion, wherein the target paging occasion is one of the plurality of paging occasions, and when the PEI indicates that no paging control information exists on the target paging occasion, entering a sleeping state on the target paging occasion; or determining the detection result is that PEI is not detected, determining that no paging control information exists on the target paging occasion, and entering a sleeping state on the target paging occasion. Thus, the UE enters the sleeping state on the target paging occasion if the PEI indicates that no paging control information exists on the target paging occasion, or if no PEI is detected by the UE, thus avoiding continuously monitoring the paging control information on the PO, reducing the power consumption of the UE, and achieving the purpose of saving the power of the UE.

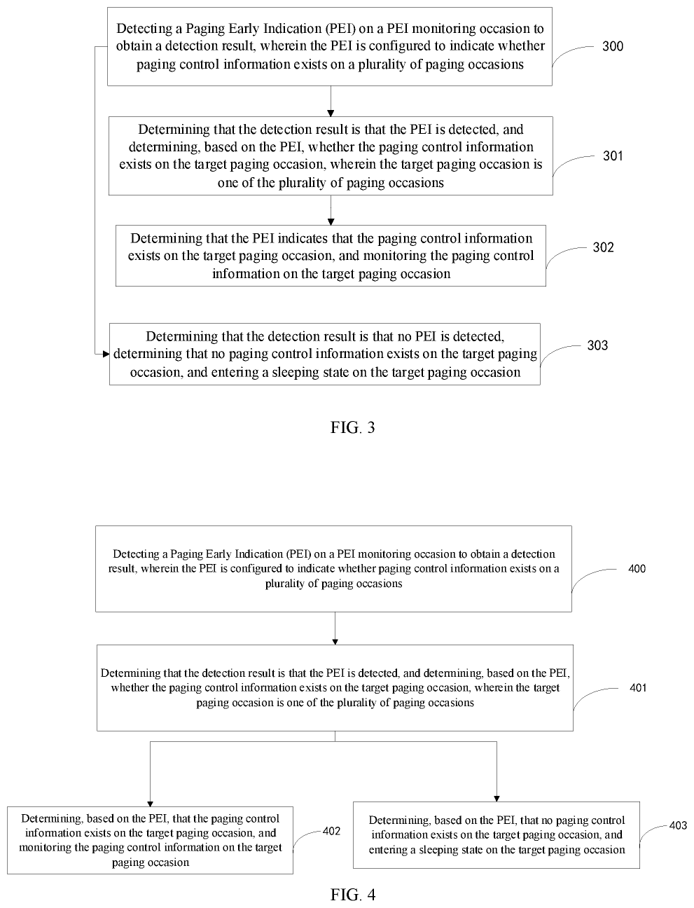

FIG. 4 is a schematic diagram of yet another method for monitoring paging control information provided by the present disclosure, which can be performed by a UE. As shown in FIG. 4, the method for monitoring the paging control information may include the following steps.

Step 400, detecting a Paging Early Indication (PEI) on a PEI monitoring occasion to obtain a detection result, wherein the PEI is configured to indicate whether paging control information exists on a plurality of paging occasions.

Step 401, determining that the detection result is that the PEI is detected, and determining, based on the PEI, whether the paging control information exists on the target paging occasion, wherein the target paging occasion is one of the plurality of paging occasions.

It should be noted that the specific implementation of step 401 can be found in the above description of step 201 and will not be repeated herein.

Step 402, determining, based on the PEI, that the paging control information exists on the target paging occasion, and monitoring the paging control information on the target paging occasion.

In some embodiments, in the case where the PEI indicates that the paging control information exists on the target paging occasion, the paging control information is monitored on the target paging occasion.

Step 403, determining, based on the PEI, that no paging control information exists on the target paging occasion, and entering a sleeping state on the target paging occasion.

In some embodiments, in the case where the PEI indicates that no paging control information exists on the target paging occasion, the UE enters the sleeping state on the target paging occasion.

It should be noted that the above step 402 and the above step 403 are juxtaposed. That is, in some embodiments, after executing step 401, step 402 may be executed, while in other embodiments, after executing step 401, step 403 may be executed.

In the method for monitoring paging control information according to the embodiments of the present disclosure, when the detection result is that the PEI is detected, based on the PEI, the UE determines whether the paging control information exists on the target paging occasion, and monitors the paging control information on the target paging occasion if the paging control information exists on the target paging occasion, or enters a sleeping state on the target paging occasion if no paging control information exists on the target paging occasion. Thus, it is convenient for the UE to determine, based on the PEI, whether the paging control information exists on its own target paging occasion, and then monitor the paging control information on the target paging occasion if the paging control information exists, or enter the sleeping state on the target paging occasion if no paging control information exists on the target paging occasion. In this way, whether the UE needs to perform the paging process is accurately indicated, thus avoiding continuously monitoring the paging control information on the PO, reducing the power consumption of the UE, and achieving the purpose of saving the power of the UE.

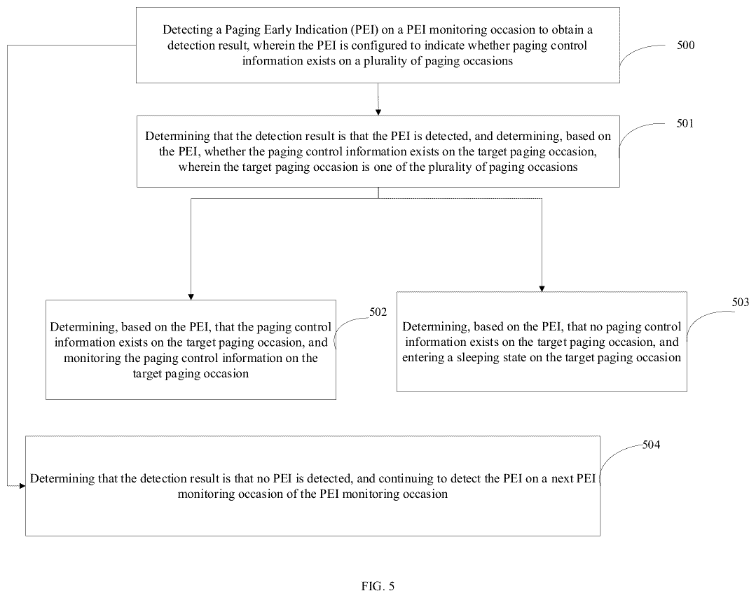

FIG. 5 is a schematic diagram of yet another method for monitoring paging control information provided by the present disclosure, which can be performed by a UE. As shown in FIG. 5, the method for monitoring the paging control information may include the following steps.

Step 500, detecting a Paging Early Indication (PEI) on a PEI monitoring occasion to obtain a detection result, wherein the PEI is configured to indicate whether paging control information exists on a plurality of paging occasions.

Step 501, determining that the detection result is that the PEI is detected, and determining, based on the PEI, whether the paging control information exists on the target paging occasion, wherein the target paging occasion is one of the plurality of paging occasions.

In this embodiment, the target paging occasion is a paging occasion that the UE needs to monitor. In some embodiments, the target paging occasion may be predetermined by the UE based on the received paging configuration information. For example, the UE may determine the target paging occasion by calculating it with a formula based on the received paging configuration information.

In some embodiments, there may be one or more PEI monitoring occasions.

It can be understood that the above step of determining whether the paging control information exists on the target paging occasion based on the PEI can be implemented in a variety of ways, as exemplarily illustrated below.

In one possible implementation, an indication value on an indication field corresponding to the target paging occasion can be determined based on the PEI; wherein the indication value is configured to indicate whether the paging control information exists on the target paging occasion; and based on the indication value, it is determined that whether the paging control information exists on the target paging occasion.

It can be understood that a plurality of indication fields are included in the PEI, and each indication field is used to indicate the presence or absence of the paging control information on the corresponding paging occasion (PO).

In some embodiments, the indication field may be a 1-bit indication field or a multi-bit indication field, which is not specifically limited in the present disclosure.

In some embodiments, in the case where the indication field is a 1-bit indication field, the presence or absence of the paging control information on the corresponding paging occasion can be indicated by an indication value of the 1-bit indication field. For example, in the case where an indication value of a 1-bit indication field corresponding to a paging occasion is 1, it can be indicated that the paging control information exists on the paging occasion corresponding to the indication field; and in the case where an indication value of a 1-bit indication field corresponding to a paging occasion is 0, it can be indicated that no paging control information exists on the paging occasion corresponding to the indication field.

For another example, in the case where an indication value of a 1-bit indication field corresponding to a paging occasion is 0, it can be indicated that the paging control information exists on the paging occasion corresponding to the indication field; and in the case where an indication value of a 1-bit indication field corresponding to a paging occasion is 1, it can be indicated that no paging control information exists on the paging occasion corresponding to the indication field.

In another possible implementation, sequence information corresponding to the PEI can be determined, and based on the sequence information, it is determined that whether the paging control information exists on the target paging occasion.

Specifically, in the case where the PEI is sent in sequence, the UE can analyze the PEI to determine the sequence information corresponding to the PEI.

In some embodiments, in the case where the sequence information of the PEI is represented in the form of a bitmap, it may be determined based on the sequence information whether the paging control information exists on the target paging occasion.

For example, assuming that the number of paging occasions indicated by the PEI is 3, when the received sequence information is “000”, it may be determined, based on a bit mapping approach, that the sequence information “000” indicates that no paging control information exists on any of the three POs. For another example, when the received sequence information is “001”, it may be determined, based on a bit mapping approach, that the sequence information indicates that no paging control information exists on the first PO as well as on the second PO, while the paging control information exists on the third PO.

In other embodiments, in the case where the PEI is represented by means of a code point, after determining the sequence information corresponding to the PEI which may include a sequence format, determining whether the paging control information exists on the target paging occasion based on the sequence information include: when the sequence format indicates that the paging control information exists on at least two paging occasions, determining that the paging control information exists on the target paging occasion; or when the sequence format indicates that the paging control information exists on the target paging occasion, determining that the paging control information exists on the target paging occasion; or when the sequence format indicates that no paging control information exists on the plurality of paging occasions, determining that no paging control information exists on the target paging occasion.

In some embodiments, in the case where the PEI is represented by means of a code point, after the PEI is detected, a code point corresponding to the PEI can be determined, and then based on the code point, a corresponding sequence format can be determined.

In some embodiments, the sequence format corresponding to the code point can be determined based on a communication protocol standard of the UE, and then, based on the information indicated by the sequence format, it can be determined whether the paging control information exists on the target paging occasion corresponding to the UE.

In other embodiments, the sequence format corresponding to the code point can be determined based on a correspondence between the code point and the sequence format pre-saved in the UE. Here, different sequence formats denote different meanings.

For example, there are four paging occasions (POs), sequence format 0, sequence format 1, sequence format 2, sequence format 3, sequence format 4, and sequence format 5, wherein sequence format i indicates that the paging control information exists on the corresponding i^{th} PO, the value of i being 0, 1, 2, or 3; sequence format 4 indicates that there are at least two POs on which the paging control information exists; and sequence format 5 indicates that there is no paging control information on any of the four paging occasions.

Step 502, determining, based on the PEI, that the paging control information exists on the target paging occasion, and monitoring the paging control information on the target paging occasion.

Step 503, determining, based on the PEI, that no paging control information exists on the target paging occasion, and entering a sleeping state on the target paging occasion.

It should be noted that the above step 502 and the above step 503 are juxtaposed. That is, in some embodiments, after executing step 501, step 502 may be executed, while in other embodiments, after executing step 501, step 503 may be executed.

Step 504, determining that the detection result is that no PEI is detected, and continuing to detect the PEI on a next PEI monitoring occasion of the PEI monitoring occasion.

In some embodiments, when the detection result is that no PEI is detected, the next PEI monitoring occasion after the PEI monitoring occasion can be obtained, and detection of the PEI continues on the next PEI monitoring occasion.

In another embodiment of the present disclosure, the method for monitoring the paging control information may include: detecting a Paging Early Indication (PEI) on a PEI monitoring occasion to obtain a detection result, wherein the PEI is configured to indicate whether paging control information exists on a plurality of paging occasions; determining that the detection result is that the PEI is detected and the PEI indicates that the paging control information exists on the target paging occasion, monitoring the paging control information on the target paging occasion; or determining that the detection result is that the PEI is not detected, continuing to detect the PEI on a next PEI monitoring occasion of the PEI monitoring occasion.

In another embodiment of the present disclosure, the method for monitoring the paging control information may include: detecting a Paging Early Indication (PEI) on a PEI monitoring occasion to obtain a detection result, wherein the PEI is configured to indicate whether paging control information exists on a plurality of paging occasions; determining that the detection result is that the PEI is detected and the PEI indicates that no paging control information exists on the target paging occasion, entering a sleeping state on the target paging occasion; or determining that no PEI is detected on the PEI monitoring occasion, continuing to detect the PEI on a next PEI monitoring occasion of the PEI monitoring occasion.

It can be understood that for different UEs, their corresponding time/frequency synchronization capabilities are different, and in order to enable UEs with different synchronization capabilities to receive the PEI, in some embodiments, the PEI in the present disclosure may correspond to a plurality of PEI monitoring occasions, and in the case where no PEI is detected on the plurality of PEI monitoring occasions corresponding to the PEI, the paging control information may be monitored on the target paging occasion.

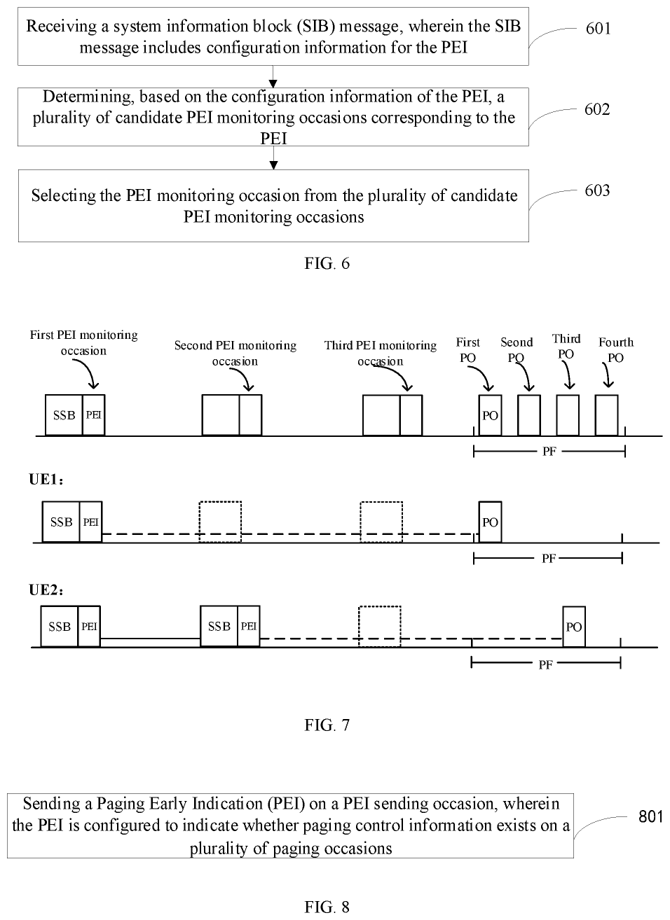

In some embodiments, in order to further reduce the power consumption of the UE, based on any of the above embodiments, the method in which the UE can predetermine the PEI monitoring occasion, as shown in FIG. 6, may include the following steps.

Step 601, receiving a system information block (SIB) message, wherein the SIB message includes configuration information for the PEI.

Step 602, determining, based on the configuration information of the PEI, a plurality of candidate PEI monitoring occasions corresponding to the PEI.

Step 603, determining the PEI monitoring occasion from the plurality of candidate PEI monitoring occasions.

In some embodiments, the PEI monitoring occasion may include one or more of the plurality of candidate PEI monitoring occasions, which is not specifically limited herein.

It can be understood that the synchronization capabilities corresponding to different UEs are different, and in order to enable the UE to accurately parse out the information in the PEI, in other embodiments, the UE may select one from the plurality of candidate PEI monitoring occasions according to its own synchronization capabilities.

In an exemplary embodiment, in the case where the PEI is sent after the Synchronization Signal or Physical Broadcast Channel (PBCH) block (SSB) and the time interval for repeated sending of the SSB is the same as the time interval for repeated sending of the PEI, UE may determine the number of synchronization signal blocks (i.e., SSBs) that are required to complete the synchronization itself, e.g., M, and selects the first M candidate PEI monitoring occasions from the plurality of candidate PEI monitoring occasions as the UE's PEI monitoring occasion.

In order to enable those skilled in the art to clearly understand the present disclosure, the present disclosure is further described below in conjunction with FIG. 7. In this embodiment, three PEI monitoring occasions and a paging frame (PF) corresponding to four POs are taken as an example for description. It should be noted that, in this embodiment, the same PEI may be sent via three PEI monitoring occasions, wherein the PEI is used to indicate whether paging control information exists on the corresponding four POs, and accordingly, the UEs within each PO may select any of the PEIs to monitor according to their respective synchronization capabilities. If UE1 has a strong synchronization capability for monitoring the first PO, UE1 may choose to monitor on the first PEI monitoring occasion shown in FIG. 7. If the PEI indicates that paging control information exists on the first PO, UE1 no longer receives the subsequent PEIs, and monitors the paging control information on the first PO directly. If the PEI indicates that no paging control information exists, UE1 skips the subsequent process, in which case UE1 no longer receives the subsequent PEIs and does not monitor the paging control information on the first PO. If UE2 requires two SSBs to complete the synchronization for monitoring the third PO, the UE2 may, based on the implementation, monitor the PEI on the first PEI monitoring occasion as well as the second PEI monitoring occasion, and if the PEI is detected and the PEI indicates that no paging control information exists on the third PO, the subsequent process is skipped. That is, the UE2 no longer receives the subsequent PEIs and does not monitor the paging control information on the third PO. If the PEI indicates that paging control information exists on the third PO, UE2 no longer receives the subsequent PEIs and directly monitors the paging control information on the third PO.

For example, the same information “1010” is sent via three PEIs and the information indicates the paging control information is sent on the first PO and the third PO in the PF. If UE1, for monitoring the first PO, detects the PEI on the first PEI monitoring occasion, and the PEI is detected, UE1 can determine that the paging control information exists on the first PO based on the PEI and no longer receive the subsequent PEIs and monitor the paging control information on the first PO. If UE2, for monitoring the third PO, requires two SSBs to complete synchronization, UE2 detects the PEI on the first PEI monitoring occasion and the second PEI monitoring occasion, and if the PEI is detected, UE2 can determine that the paging control information exists on the third PO based on the PEI. In this case, UE2 no longer receives the subsequent PEIs, and monitors the paging control information directly on the third PO.

In this embodiment, in combination with the configuration information of the PEI in the SIB message, a plurality of candidate PEI monitoring occasions corresponding to the PEI are determined, and the PEI monitoring occasion is selected from the plurality of candidate PEI monitoring occasions, so that the UE can detect the PEI at the selected PEI monitoring occasion, which avoids the UE from detecting the PEI at all times, and thus reduces the power consumption of the UE and achieves the purpose of power saving.

Based on the above embodiments, it can be understood that the above step of determining the plurality of candidate PEI monitoring occasions corresponding to the PEI based on the configuration information of the PEI, can be implemented in a variety of ways, as exemplarily illustrated below.

In a possible implementation, the configuration information of the PEI described above may include indication information for indicating the plurality of candidate PEI monitoring occasions, and accordingly, the UE may determine, based on the indication information, the plurality of candidate PEI monitoring occasions for detecting the PEI.

In another possible implementation, the configuration information of the PEI described above may include: N PEIs, N being a positive integer; a time interval for repeatedly sending the PEI; an offset value between the last PEI of the N PEIs and the first paging occasion of the plurality of paging occasions; and a number of paging occasions corresponding to the PEI. After obtaining the configuration information of the PEI, N candidate PEI monitoring occasions corresponding to the N PEIs may be determined based on the configuration information of the PEI and the communication protocol standard.

In yet another possible implementation, the configuration information of the PEI described above may include: N PEIs, N being a positive integer; a time interval for repeatedly sending the PEI; an offset value between the last PEI of the N PEIs and the first paging occasion of the plurality of paging occasions; and a number of paging occasions corresponding to the PEI. After obtaining the configuration information of the PEI, N candidate PEI monitoring occasions corresponding to the N PEIs may be determined based on the time interval and the offset value.

FIG. 8 is a schematic diagram of a method for indicating paging control information provided by the embodiments of the present disclosure. The method for indicating paging control information is performed by a network side device. In some embodiments, the network side device may be a base station.

As shown in FIG. 8, the method for indicating the paging control information may include the following steps.

Step 801, sending a Paging Early Indication (PEI) on a PEI sending occasion, wherein the PEI is configured to indicate whether paging control information exists on a plurality of paging occasions.

In some embodiments, there may be one or more PEI sending occasions.

In other embodiments, in order to enable UEs with different synchronization capabilities to receive the PEI, the PEI sending occasion can be more than one. That is, the PEI is sent on a plurality of PEI sending occasions. Here, the PEIs sent on respective sending occasions are the same. In this way, UEs with different synchronization capabilities on the same PO can be accommodated.

In the method for indicating the paging control information of the embodiments of the present disclosure, the PEI that indicates whether or not the paging control information exists on the plurality of paging occasions is sent on the PEI sending occasion, so that the corresponding UE can determine whether or not the paging control information exists on its own paging occasion from the PEI, and determine whether or not to monitor the paging control information on its own paging occasion based on the PEI. Thus, it is realized that one PEI indicates the paging control information on the plurality of paging occasions, avoiding the need to send one PEI for each of the different UEs and reducing the network signaling overhead.

FIG. 9 is a schematic diagram of a method for indicating paging control information provided by the embodiments of the present disclosure. The method for indicating the paging control information is performed by a network side device. In some embodiments, the network side device may be a base station.

In some embodiments, in order to enable the UE to detect the PEI on the PEI monitoring occasion, as shown in FIG. 9, the method may further include the following steps.

Step 901, sending a system information block (SIB) message, wherein the SIB message includes configuration information for the PEI and the configuration information of the PEI is configured to determine a PEI monitoring occasion for monitoring the PEI.

Step 902, sending a Paging Early Indication (PEI) on a PEI sending occasion, wherein the PEI is configured to indicate whether paging control information exists on a plurality of paging occasions.

In this embodiment, the network side device informs the UE of the configuration information of the PEI by means of the SIB message before sending the PEI on the PEI sending occasion, and then, the UE can be informed of the PEI monitoring occasion for the detection of the PEI based on the configuration information of the PEI.

In some embodiments, in order to enable the UE to accurately determine the PEI monitoring occasion based on the configuration information of the PEI, the configuration information of the PEI includes: N PEIs, N being a positive integer; a time interval for repeatedly sending the PEI; an offset value between the last PEI of the N PEIs and the first paging occasion of the plurality of paging occasions; and a number of paging occasions corresponding to the PEI.

A relevant description of the UE determining a plurality of candidate PEI monitoring occasions corresponding to the N PEIs based on the configuration information of the PEI can be found in the relevant description of the above embodiments and will not be repeated herein.

According to an aspect of the present disclosure, a method for monitoring paging control information is provided, which is performed by a UE. The method includes: detecting a Paging Early Indication (PEI) on a PEI monitoring occasion to obtain a detection result, wherein the PEI is configured to indicate whether paging control information exists on a plurality of paging occasions; and determine, based on the detection result, whether to monitor the paging control information on a target paging occasion, wherein the target paging occasion is one of the plurality of paging occasions.

In some embodiments, the determining, based on the detection result, whether to monitor the paging control information on the target paging occasion, includes: determining that the detection result is that the PEI is not detected, and determining that no paging control information exists on the target paging occasion and entering a sleeping state on the target paging occasion; or determining that the detection result is that the PEI is detected, and determining, based on the PEI, whether to monitor the paging control information on the target paging occasion.

In some embodiments, the determining, based on the PEI, whether to monitor the paging control information on the target paging occasion, includes: determining, based on the PEI, an indication value on an indication field corresponding to the target paging occasion, wherein the indication value is configured to indicate whether the paging control information exists on the target paging occasion; and determining, based on the indication value, whether to monitor the paging control information on the target paging occasion.

In some embodiments, the determining, based on the PEI, whether to monitor the paging control information on the target paging occasion, includes: determining sequence information corresponding to the PEI; and determining, based on the sequence information, whether to monitor the paging control information on the target paging occasion.

In some embodiments, the determining, based on the PEI, whether to monitor the paging control information on the target paging occasion, includes: determining that the PEI indicates that no paging control information exists on the target paging occasion, and entering a sleeping state on the target paging occasion; or determining that the PEI indicates that the paging control information exists on the target paging occasion, and monitoring the paging control information on the target paging occasion.

In some embodiments, the method further includes: determining that no PEI is detected on a plurality of PEI monitoring occasions corresponding to the PEI, and monitoring the paging control information on the target paging occasion.

In some embodiments, the method further includes: receiving a system information block (SIB) message, wherein the SIB message includes configuration information for the PEI; determining, based on the configuration information of the PEI, a plurality of candidate PEI monitoring occasions corresponding to the PEI; and selecting the PEI monitoring occasion from the plurality of candidate PEI monitoring occasions.

In some embodiments, the configuration information of the PEI includes: N PEIs, N being a positive integer; a time interval for repeatedly sending the PEI; an offset value between the last PEI of the N PEIs and the first paging occasion of the plurality of paging occasions; and a number of paging occasions corresponding to the PEI.

In some embodiments, the determining, based on the configuration information of the PEI, the plurality of candidate PEI monitoring occasions corresponding to the PEI, includes: determining N candidate PEI monitoring occasions corresponding to the N PEIs based on the time interval and the offset value.

According to another aspect of the present disclosure, a method for indicating paging control information is provided, which is performed by a network side device. The method includes: sending a Paging Early Indication (PEI) on a PEI sending occasion, wherein the PEI is configured to indicate whether paging control information exists on a plurality of paging occasions.

In some embodiments, the PEI sending occasion is multiple.

In some embodiments, before sending the PEI on the PEI sending occasion, the method further includes: sending a system information block (SIB) message, wherein the SIB message includes configuration information for the PEI, and the configuration information of the PEI is configured to determine a PEI monitoring occasion for monitoring the PEI.

In some embodiments, the configuration information of the PEI includes: N PEIs, N being a positive integer; a time interval for repeatedly sending the PEI; an offset value between the last PEI of the N PEIs and the first paging occasion of the plurality of paging occasions; and a number of paging occasions corresponding to the PEI.

According to yet another aspect of embodiments of the present disclosure, a computer program product is provided, the computer program product including a computer program which, when executed by a processor of a communication device, causes the processor to implement the method for monitoring the paging control information as described in the first aspect of the embodiments of the present disclosure, or the method for indicating the paging control information as described in the second aspect of the embodiments of the present disclosure.

The present disclosure also provides an apparatus for monitoring paging control information corresponding to the method for monitoring paging control information provided in the above-described embodiments. Since the apparatus for monitoring paging control information provided in the embodiments of the present disclosure corresponds to the method for monitoring paging control information provided in the above-described embodiments, the implementation of the method for monitoring paging control information is also applicable to the apparatus for monitoring paging control information provided in the present disclosure, and will not be described in detail herein.

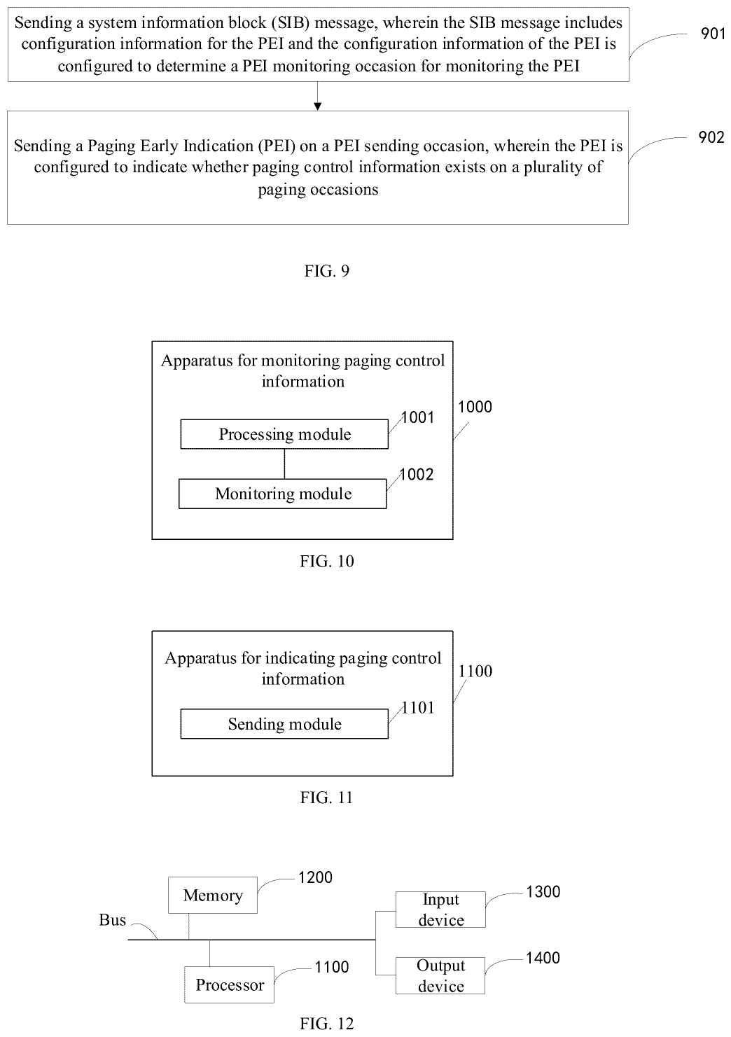

FIG. 10 is a schematic diagram of a structure of an apparatus for monitoring paging control information provided by the present disclosure. It should be noted that the apparatus is applied to a UE.

As shown in FIG. 10, the apparatus 1000 for monitoring the paging control information may include:
a processing module 1001 configured to detect a Paging Early Indication (PEI) on a PEI monitoring occasion to obtain a detection result, wherein the PEI is configured to indicate whether paging control information exists on a plurality of paging occasions; and
a monitoring module 1002 configured to determine, based on the detection result, whether to monitor the paging control information on a target paging occasion, wherein the target paging occasion is one of the plurality of paging occasions.

In the apparatus for monitoring paging control information according to the embodiments of the present disclosure, the PEI is detected on the PEI monitoring occasion to obtain the detection result, and based on the detection result, it is determined whether or not to monitor the paging control information on the target paging occasion. Thus, the UE can determine whether to monitor the paging control information on the target paging occasion based on the detection result of the PEI, thereby avoiding the UE from continuously monitoring the paging control information on the PO, and reducing the power consumption of the UE.

In an embodiment of the present disclosure, the monitoring module is specifically configured to: determine that the detection result is that the PEI is detected, and determine, based on the PEI, whether to monitor the paging control information on the target paging occasion; or determine that the detection result is that the PEI is not detected, and continue to detect the PEI on a next PEI monitoring occasion of the PEI monitoring occasion

In an embodiment of the present disclosure, the monitoring module 1002 is specifically configured to: determine that the detection result is that the PEI is not detected, determine that no paging control information exists on the target paging occasion, and enter a sleeping state on the target paging occasion; or determine that the detection result is that the PEI is detected, and determine, based on the PEI, whether to monitor the paging control information on the target paging occasion.

In an embodiment of the present disclosure, the monitoring module 1002 is specifically configured to: determine, based on the PEI, an indication value on an indication field corresponding to the target paging occasion, wherein the indication value is configured to indicate whether the paging control information exists on the target paging occasion; and determine, based on the indication value, whether to monitor the paging control information on the target paging occasion.

In an embodiment of the present disclosure, the monitoring module 1002 is specifically configured to: determine sequence information corresponding to the PEI; and determine, based on the sequence information, whether to monitor the paging control information on the target paging occasion.

In an embodiment of the present disclosure, the monitoring module 1002 is specifically configured to: determine that the PEI indicates that no paging control information exists on the target paging occasion, and enter a sleeping state on the target paging occasion; or determine that the PEI indicates that the paging control information exists on the target paging occasion, and monitor the paging control information on the target paging occasion.

In an embodiment of the present disclosure, the monitoring module 1002 is further configured to: determine that no PEI is detected on a plurality of PEI monitoring occasions corresponding to the PEI, and monitor the paging control information on the target paging occasion.

In an embodiment of the present disclosure, the processing module 1001 is further configured to: receive a system information block (SIB) message, wherein the SIB message includes configuration information for the PEI. The apparatus 1000 for monitoring the paging control information further includes: a determination module (not shown) configured to determine, based on the configuration information of the PEI, a plurality of candidate PEI monitoring occasions corresponding to the PEI; and select the PEI monitoring occasion from the plurality of candidate PEI monitoring occasions.

In an embodiment of the present disclosure, the configuration information of the PEI includes: N PEIs, N being a positive integer; a time interval for repeatedly sending the PEI; an offset value between the last PEI of the N PEIs and the first paging occasion of the plurality of paging occasions; and a number of paging occasions corresponding to the PEI.

In an embodiment of the present disclosure, the processing module 1001 is further configured to: determine N candidate PEI monitoring occasions corresponding to the N PEIs based on the time interval and the offset value.

The specific description of the apparatus for monitoring paging control information can be found in the description of the embodiments shown in FIGS. 1 to 6 above, and will not be repeated herein.

The present disclosure also provides an apparatus for indicating paging control information corresponding to the method for indicating paging control information provided in the above-described embodiments. Since the apparatus for indicating paging control information provided in the embodiments of the present disclosure corresponds to the method for indicating paging control information provided in the above-described embodiments, the implementation of the method for indicating paging control information is also applicable to the apparatus for indicating paging control information provided in the present disclosure, and will not be described in detail herein.

FIG. 11 is a schematic diagram of a structure of an apparatus for indicating paging control information provided by the present disclosure. It should be noted that the apparatus may be configured in a network side device, which may be a base station in some embodiments.

As shown in FIG. 11, the apparatus 1100 for indicating paging control information may include:
a sending module 1101 configured to send a Paging Early Indication (PEI) on a PEI sending occasion, wherein the PEI is configured to indicate whether paging control information exists on a plurality of paging occasions.

In an embodiment of the present disclosure, the PEI sending occasion is multiple.

In an embodiment of the present disclosure, the sending module 1101 is further configured to: send a system information block (SIB) message, wherein the SIB message includes configuration information for the PEI, and the configuration information of the PEI is configured to determine a PEI monitoring occasion for monitoring the PEI.

In an embodiment of the present disclosure, the configuration information of the PEI includes: N PEIs, N being a positive integer; a time interval for repeatedly sending the PEI; an offset value between the last PEI of the N PEIs and the first paging occasion of the plurality of paging occasions; and a number of paging occasions corresponding to the PEI.

The specific description of the apparatus for indicating paging control information can be found in the description of the embodiments shown in FIGS. 8 to 9 above, and will not be repeated herein.

In the apparatus for indicating paging control information according to the embodiments of the present disclosure, the PEI that indicates whether or not the paging control information exists on the plurality of paging occasions is sent on the PEI sending occasion, so that the corresponding UE can determine whether or not the paging control information exists on its own paging occasion from the PEI, and determine whether or not to monitor the paging control information on the target paging occasion based on the PEI. Thus, it is realized that one PEI indicates the paging control information on the plurality of paging occasions, avoiding the need to send one PEI for each of the different UEs and reducing the network signaling overhead.

According to the embodiments of the present disclosure, the present disclosure further provides a communication device and a readable storage medium.

FIG. 12 is a block diagram of a communication device according to embodiments of the present disclosure. The communication device is intended to represent various forms of digital computers, such as, laptops, desktop computers, workstations, personal digital assistants, servers, blade servers, mainframe computers, and other suitable computers. The communication device may also represent various forms of mobile devices such as, personal digital processing devices, cellular phones, smart phones, wearable devices, and other similar computing devices. The components shown herein, their connections and relationships, and their functionality are shown as examples only and are not intended to limit the implementations of the present disclosure described and/or claimed herein.

As shown in FIG. 12, the communication device includes: one or more processors 1500, memory 1200, and interfaces for connecting the various components, including a high speed interface and a low speed interface. The various components are interconnected utilizing different buses and may be mounted on a common motherboard or otherwise mounted as desired. The processor may process instructions executed within the communication device, including instructions stored in or on memory to display graphical information of the GUI on an external input/output device (e.g., a display device coupled to the interface). In other embodiments, multiple processors and/or multiple buses may be used with multiple memories and multiple memories, if desired. Similarly, multiple communication devices may be connected, with individual devices providing some of the necessary operations (e.g., as a server array, a group of blade servers, or a multi-processor system). FIG. 12 is shown using one processor 1500 as an example.

The memory 1200 is the non-transitory computer-readable storage medium provided by the present disclosure. The memory stores instructions executable by the at least one processor to cause the at least one processor to execute a method for monitoring paging control information, or, a method for indicating paging control information provided by the present disclosure. The non-transitory computer-readable storage medium of the present disclosure stores computer instructions for causing the computer to perform a method for monitoring paging control information, or, a method for indicating paging control information provided by the present disclosure.

The memory 1200, as a non-transitory computer-readable storage medium, may be used to store non-transitory software programs, non-transitory computer-executable programs, and modules, such as program instructions/modules corresponding to the method for monitoring paging control information in the embodiments of the present disclosure (e.g., the processing module 1001 and the monitoring module 1002 shown in FIG. 10 of the accompanying drawings, or, the sending module 1101 shown in FIG. 11 of the accompanying drawings). The processor 1500 executes various functional applications of the server and data processing by running the non-transitory software programs, instructions, and modules stored in the memory 1200, i.e., realizing the method for monitoring the paging control information or, alternatively, the method for indicating the paging control information in the method embodiments described above.

The memory 1200 may include a storage program area and a storage data area. The storage program area may store an operating system, an application program required for at least one function, and the storage data area may store data created based on the use of positioning communication device, etc. Additionally, the memory 1200 may include a high-speed random access memory, and may also include a non-transient memory, such as at least one disk memory device, a flash memory device, or other non-transient solid state memory device. Optionally, the memory 1200 may include memories set remotely with respect to the processor 1500, and these remote memories may be connected to the positioning communication device via a network. Examples of the network include, but are not limited to, the Internet, an enterprise intranet, a local area network, a mobile communication network, and combinations thereof.

The communication device may also include: an input device 1300 and an output device 1400. The processor 1500, the memory 1200, the input device 1300, and the output device 1400 may be connected via a bus or otherwise. FIG. 12 shows an example of a bus connection.

The input device 1300 may receive input numeric or character information, as well as generate inputs of key signals related to user settings and function control of the positioning communication device, such as a touch screen, keypad, mouse, track pad, touch pad, indicator bar, one or more mouse buttons, trackball, joystick, and other input devices. The output device 1400 may include a display device, an auxiliary lighting device (e.g., an LED), and a haptic feedback device (e.g., a vibration motor), among others. The display device may include, but is not limited to, a liquid crystal display (LCD), a light emitting diode (LED) display, and a plasma display. In some embodiments, the display device may be a touch screen.

Various embodiments of the systems and techniques described herein may be implemented in digital electronic circuit systems, integrated circuit systems, Application-Specific Integrated Circuits (ASICs), computer hardware, firmware, software, and/or combinations thereof. These various embodiments may include embodiments in one or more computer programs that may be executed and/or interpreted on a programmable system including at least one programmable processor. The programmable processor may be a dedicated or general-purpose programmable processor, that receives data and instructions from a storage system, at least one input device, and at least one output device, and that transmits data and instructions to that storage system, at least one input device, and at least one output device.

These computational programs (also referred to as programs, software, software applications, or code) include machine instructions for the programmable processor and may be implemented using high-level procedural and/or object-oriented programming languages, and/or assembly/machine languages. As used herein, the terms “machine-readable medium” and “computer-readable medium” refer to any computer program product, device, and/or apparatus (e.g., a disk, CD-ROM, memory, programmable logic device (PLD)) used to provide machine instructions and/or data to a programmable processor, including machine-readable media that receives machine instructions as machine-readable signals. The term “machine-readable signal” refers to any signal used to provide machine instructions and/or data to a programmable processor.

To provide interaction with a user, the systems and techniques described herein may be implemented on a computer having: a display device (e.g., a cathode ray tube (CRT) or liquid crystal display (LCD) monitor) for displaying information to the user; and a keyboard and a pointing device (e.g., a mouse or a trackball) by which the user may provide input to the computer. Other types of devices may also be used to provide interaction with the user; for example, the feedback provided to the user may be any form of sensory feedback (e.g., visual feedback, auditory feedback, or tactile feedback); and the input from the user may be received in any form, including acoustic, voice, or tactile input.

The systems and techniques described herein may be implemented in a computing system that includes a back-end component (e.g., serving as a data server), or a computing system that includes a middleware component (e.g., an application server), or a computing system that includes a front-end component (e.g., a user's computer that has a graphical user interface or a web browser through which a user can interact with embodiments of the systems and techniques described herein), or in a computing system that includes any combination of such back-end component, middleware component, or front-end component. The components of the system may be interconnected by digital data communications (e. g., a communication network) in any form or medium. Examples of the communication network include: local area networks (LANs), wide area networks (WANs), and the Internet.

A computer system may include a client and a server. The client and server are generally remote from each other and usually interact over a communication network. The client-server relationship is created by computer programs that run on corresponding computers and have a client-server relationship with each other.

In the embodiments of the present disclosure, when the detection result is that the PEI is detected, based on the PEI, the UE determines whether the paging control information exists on the target paging occasion, and monitors the paging control information on the target paging occasion if the paging control information exists on the target paging occasion. Thus, it is convenient for the UE to determine, based on the PEI, whether the paging control information exists on its own target paging occasion, and then monitor the paging control information on the target paging occasion if the paging control information exists, so as to avoid continuously monitoring the paging control information on the PO, and to reduce the power consumption of the UE.

It should be understood that steps may be reordered, added or deleted using various forms of the processes illustrated above. For example, the steps recorded in the present application may be performed in parallel or sequentially or in a different order as long as the desired results of the technical solutions disclosed in the present disclosure can be achieved, and are not limited herein.

The above specific embodiments do not constitute a limitation on the scope of protection of the present disclosure. It should be understood by those skilled in the art that various modifications, combinations, sub-combinations, and substitutions may be made according to design requirements and other factors. Any modifications, equivalent substitutions, improvements, etc. made within the spirit and principles of the present disclosure shall be included within the scope of protection of the present disclosure.

1. A method for monitoring paging control information, performed by a User Equipment (UE), the method comprising:
detecting a Paging Early Indication (PEI) on a PEI monitoring occasion to obtain a detection result, wherein the PEI is configured to indicate whether paging control information exists on a plurality of paging occasions; and
determining, based on the detection result, whether to monitor the paging control information on a target paging occasion, wherein the target paging occasion is one of the plurality of paging occasions.

2. The method of claim 1, wherein the determining, based on the detection result, whether to monitor the paging control information on the target paging occasion, comprises:
determining that the detection result is that the PEI is detected, and determining, based on the PEI, whether to monitor the paging control information on the target paging occasion; or
determining that the detection result is that the PEI is not detected, and continuing to detect the PEI on a next PEI monitoring occasion of the PEI monitoring occasion.

3. The method of claim 1, wherein the determining, based on the detection result, whether to monitor the paging control information on the target paging occasion, comprises:
determining that the detection result is that the PEI is not detected, determining that no paging control information exists on the target paging occasion, and entering a sleeping state on the target paging occasion; or
determining that the detection result is that the PEI is detected, and determining, based on the PEI, whether to monitor the paging control information on the target paging occasion.

4. The method of claim 2, wherein the determining, based on the PEI, whether to monitor the paging control information on the target paging occasion, comprises:
determining, based on the PEI, an indication value on an indication field corresponding to the target paging occasion, wherein the indication value is configured to indicate whether the paging control information exists on the target paging occasion; and
determining, based on the indication value, whether to monitor the paging control information on the target paging occasion.

5. The method of claim 2, wherein the determining, based on the PEI, whether to monitor the paging control information on the target paging occasion, comprises:
determining sequence information corresponding to the PEI; and
determining, based on the sequence information, whether to monitor the paging control information on the target paging occasion.

6. The method of claim 2, wherein the determining, based on the PEI, whether to monitor the paging control information on the target paging occasion, comprises:
determining that the PEI indicates that no paging control information exists on the target paging occasion, and entering a sleeping state on the target paging occasion; or
determining that the PEI indicates that the paging control information exists on the target paging occasion, and monitoring the paging control information on the target paging occasion.

7. The method of claim 2, further comprising:
determining that no PEI is detected on a plurality of PEI monitoring occasions corresponding to the PEI, and monitoring the paging control information on the target paging occasion.

8. The method of claim 1, further comprising:
receiving a system information block (SIB) message, wherein the SIB message comprises configuration information for the PEI;
determining, based on the configuration information of the PEI, a plurality of candidate PEI monitoring occasions corresponding to the PEI; and
selecting determining the PEI monitoring occasion from the plurality of candidate PEI monitoring occasions.

9. The method of claim 8, wherein the configuration information of the PEI comprises:
a time interval for repeatedly sending the PEI;
N PEIs corresponding to the repeatedly sending of the PEI, wherein N is a positive integer;
an offset value between a last PEI of the N PEIs and a first paging occasion of the plurality of paging occasions; and
a number of paging occasions corresponding to each of the N PEIs.

10. The method of claim 9, wherein the determining, based on the configuration information of the PEI, the plurality of candidate PEI monitoring occasions corresponding to the PEI, comprises:
determining N candidate PEI monitoring occasions corresponding to the N PEIs based on the time interval and the offset value.

11. A method for indicating paging control information, performed by a network side device, the method comprising:
sending a Paging Early Indication (PEI) on least one PEI sending occasion, wherein the PEI is configured to indicate whether paging control information exists on a plurality of paging occasions.

12. The method of claim 11, wherein the at least one PEI sending occasion comprises a plurality of PEI sending occasions.

13. The method of claim 11, wherein before sending the PEI on the PEI sending occasion, the method further comprises:
sending a system information block (SIB) message, wherein the SIB message comprises configuration information for the PEI, and the configuration information of the PEI is configured for a User Equipment (UE) to determine a PEI monitoring occasion for monitoring the PEI.

14. The method of claim 13, wherein the configuration information of the PEI comprises:
a time interval for repeatedly sending the PEI;
N PEIs corresponding to the repeatedly sending of the PEI, wherein N is a positive integer;
an offset value between a last PEI of the N PEIs and a first paging occasion of the plurality of paging occasions; and
a number of paging occasions corresponding to each of the N PEIs.

15.-16. (canceled)

17. A communication device, comprising:
a processor; and
a memory connected in communication with the processor;
wherein the memory stores one or more instructions executable by the processor which, when executed by the processor, cause the processor to:
detect a Paging Early Indication (PEI) on a PEI monitoring occasion to obtain a detection result, wherein the PEI is configured to indicate whether paging control information exists on a plurality of paging occasions; and
determine, based on the detection result, whether to monitor the paging control information on a target paging occasion, wherein the target paging occasion is one of the plurality of paging occasions.

18. A communication device, comprising:
a processor; and
a memory connected in communication with the processor;
wherein the memory stores one or more instructions executable by the processor which, when executed by the processor, cause the processor to perform the method of claim 11.

19. A non-transitory computer storage medium, storing one or more computer-executable instructions which, when executed by a processor, cause the processor to implement the method of claim 1.

20. The method of claim 3, wherein the determining, based on the PEI, whether to monitor the paging control information on the target paging occasion, comprises:
determining, based on the PEI, an indication value on an indication field corresponding to the target paging occasion, wherein the indication value is configured to indicate whether the paging control information exists on the target paging occasion; and
determining, based on the indication value, whether to monitor the paging control information on the target paging occasion.

21. The method of claim 3, wherein the determining, based on the PEI, whether to monitor the paging control information on the target paging occasion, comprises:
determining sequence information corresponding to the PEI; and
determining, based on the sequence information, whether to monitor the paging control information on the target paging occasion.

22. The method of claim 3, wherein the determining, based on the PEI, whether to monitor the paging control information on the target paging occasion, comprises:
determining that the PEI indicates that no paging control information exists on the target paging occasion, and entering a sleeping state on the target paging occasion; or
determining that the PEI indicates that the paging control information exists on the target paging occasion, and monitoring the paging control information on the target paging occasion.
